(19) United States
(12) Patent Application Publication
(10) Pub. No.: US 2014/0196682 A1
(43) Pub. Date: Jul. 17, 2014

(54) PRESSURIZED ENGINE ENCLOSURE WITH AIR FILTER FOR AN AGRICULTURAL WORK VEHICLE

(71) Applicant: DEERE & COMPANY, Moline, IL (US)

(72) Inventors: Alan Sheidler, Moline, IL (US); Timothy Christensen, Moline, IL (US)

(73) Assignee: Deere & Company, Moline, IL (US)

(21) Appl. No.: 13/741,960

(22) Filed: Jan. 15, 2013

(51) Int. Cl. F02F 7/00

(52) U.S. Cl. CPC F02F 7/0021
USPC 123/195 R

(57) ABSTRACT

An engine enclosure (100, 200) for an agricultural work vehicle has a plurality of walls (114, 210, 216, 218, 230) that surround an internal combustion engine (102, 202) and a fan (122, 236) coupled to an air inlet (120, 238) in the plurality of walls for maintaining the inside of the engine enclosure (100, 200) at a pressure slightly higher than atmospheric pressure.

### FIELD

The field is work vehicles. More particularly, the field is engines and engine compartments for agricultural work vehicles.

### BACKGROUND

Agricultural work vehicles travel through agricultural fields planting, cultivating, treating and harvesting crops. These vehicles are often surrounded by clouds of light combustible matter, such as leaves, dust, chaff, and the like.

This light combustible matter will accumulate in areas with stagnant air flow, often settling out and coating surfaces of high temperature objects such as exhaust pipes, turbochargers, diesel particulate filters, and the like. It is a concern that this accumulated light material will combust when otherwise cool surfaces are periodically cycled to extremely hot temperatures, such as a diesel particulate filter experiences during its regeneration process.

There are many prior art arrangements that enclose an engine block and associated components. These can be seen in U.S. Pat. No. 4,324,208, U.S. Pat. No. 4,610,326, U.S. Pat. No. 4,891,940, U.S. Pat. No. 7,523,726, U.S. Pat. No. 2,250,382, U.S. Pat. No. 4,241,702, U.S. Pat. No. 3,949,726, and GB 1,397,476.

These arrangements, however, are not directed to the problem of solving the accumulation of light combustible particles on exhaust gas aftertreatment devices such as diesel particulate filters. Instead, they are directed to ways of soundproofing engines, air cooling engines, cooling of mufflers, and the like.

Some prior art arrangements are directed to the problem of combustible particles accumulating on diesel particulate filters or other hot exhaust gas conduits. These have proposed directing a flow of air (both clean and dirty) either continuously or intermittently across surfaces on which the particles may accumulate to either prevent the accumulation of light combustible particles or to periodically blow the light combustible particles off the surfaces. These prior art arrangements use the kinetic energy of air and therefore require nozzles located close to all of the surfaces on which particles might accumulate and a relatively large fan to supply air at a sufficient velocity.

Both of these cleaning arrangements do not prevent light combustible materials from reaching the hot surfaces. Instead they deflect the light combustible material before it settles, or blow it off the surfaces before the surfaces are heated up sufficient to ignite the light particles.

These cleaning arrangements are typically employed in vehicles in which a large volume of air is directed through an engine coolant heat exchanger and then through the engine compartment, across the surface of the engine and the other hot surfaces. Engine coolant heat exchangers typically require a large supply of air passing therethrough to extract sufficient heat from the engine coolant.

A further problem with these cleaning arrangements is that so much air must pass through the engine coolant heat exchangers in order for them to work that it is impossible to filter the air sufficiently to remove all of the light combustible material. Much of the light combustible material is dust, and therefore would require filtering at a micron level in order to prevent its accumulation on surfaces inside the engine compartment.

What is needed, therefore, is an improved method for preventing light combustible matter from accumulating on hot surfaces in the engine enclosure of an agricultural vehicle. What is also needed is a method that will not require extremely fine filtering of large quantities of engine cooling air and the attendant cleaning and replacement of filter elements.

It is an object of this invention to provide such a system.

### SUMMARY

In one arrangement, a vehicle configured to work in an agricultural field has an internal combustion engine that is disposed inside an engine enclosure in the form of a box. The engine enclosure defines an air inlet. A source of air is coupled to the air inlet and generates an air flow into the engine enclosure. The source of air produces a slight positive pressure in the engine enclosure. The source of air maintains the air pressure in the engine enclosure slightly higher than the air pressure of the ambient environment surrounding the engine enclosure. The pressure produced by the source of air prevents dust and debris from entering the engine enclosure.

In another arrangement, an engine enclosure for an internal combustion engine is provided that comprises a plurality of walls surrounding the internal combustion engine, wherein the walls define an air inlet opening into a space between the internal combustion engine and the plurality of walls, and the fan coupled to the air inlet to provide air under pressure to the space between the internal combustion engine and the plurality of walls, and to maintain the air in the space at a pressure above the air pressure outside the plurality of walls.

The engine enclosure may further comprise a combustion air conduit coupled to the internal combustion engine to supply the internal combustion engine with air for internal combustion, wherein at least a portion of said combustion air conduit is disposed inside the engine enclosure.

The combustion air conduit may extend through a wall of the plurality of walls.

An end of the combustion air conduit may be disposed outside of the engine enclosure to receive ambient air from the environment outside of the engine enclosure and to conduct the ambient air through the wall of the plurality of walls and into the internal combustion engine.

The fan may be disposed to receive ambient air from outside the engine enclosure and to convey the ambient air into the air inlet.

An air filter may be disposed between the fan and the ambient environment to filter ambient air before it is conveyed into the air inlet.

The engine enclosure may further comprise a heat exchanger disposed outside of the engine enclosure, and configured to receive ambient air from the ambient environment outside of the engine compartment, to transfer heat to the ambient air and to transmit now-heated ambient air back into the ambient environment outside of the engine compartment.

The engine enclosure may further comprise a first engine coolant conduit coupled to and extending between the internal combustion engine and the heat exchanger to conduct hot engine coolant from the engine to the heat exchanger for cooling, and a second engine coolant conduit coupled to and extending between the internal combustion engine and the heat exchanger to conduct engine coolant from the heat exchanger back to the engine after cooling.

The first engine coolant conduit and the second engine coolant conduit may extend through a wall of the engine enclosure.

The engine enclosure may further comprise a PTO gearbox disposed inside the plurality of walls that is coupled to the internal combustion engine to be driven thereby.

The engine enclosure may further comprise an output driveshaft coupled to and driven by the PTO gearbox.

The output driveshaft may extend through a wall of the plurality of walls.

The output driveshaft may be coupled to and may drive a driven machine disposed outside of the plurality of walls.

The engine enclosure may further comprise an air vent extending from a wall of the plurality of walls and configured to communicate air from inside the engine enclosure to the ambient atmosphere outside of the engine enclosure thereby preventing overpressure of the engine enclosure.

The plurality of walls may enclose a turbocharger that is coupled to the engine to pressurize combustion air for the engine.

### BRIEF DESCRIPTION OF THE FIGURES

FIG. 1 is a schematic diagram of an engine enclosure in accordance with the present invention.

FIG. 2 is a schematic diagram of an alternative engine enclosure in accordance with the present invention.

### DETAILED DESCRIPTION

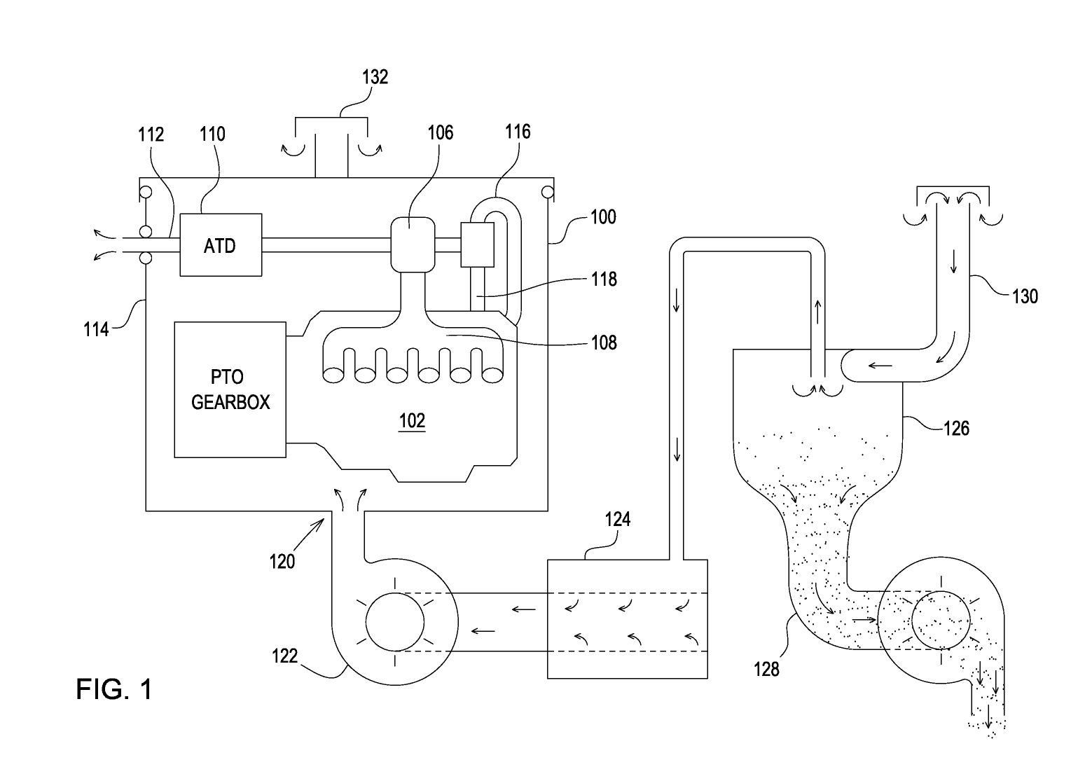

Referring to FIG. 1, an engine enclosure 100 surrounds an internal combustion engine 102 that is coupled to a gearbox 104. A turbocharger 106 is driven by exhaust gas leaving an exhaust manifold 108 of the internal combustion engine 102. The exhaust gas passes through an exhaust gas aftertreatment device 110 and thence through a conduit 112 that passes through a wall 114 of the engine enclosure 100. Turbocharger 106 sucks air into a combustion air conduit 116, pressurizes it, and transmits it through a combustion air outlet 118 into the internal combustion engine 102. An air inlet 120 is provided in a wall of the engine enclosure 100 to receive air pressurized by a fan 122. Fan 122 has an air inlet that is coupled to and receives air from an air filter 124. The air filter 124 is coupled to and receives air from a cyclone separator 126. The cyclone separator 126 has a debris outlet 128 that receives debris, dust, and other solid particles from the cyclone separator 126. The cyclone separator 126 has an intake air inlet 130 that receives air from the ambient atmosphere. An air vent 132 is provided in a wall of the engine enclosure 100 to permit excess air inside the engine enclosure 100 to escape the engine enclosure 100 thereby preventing overpressure of the engine enclosure 100.

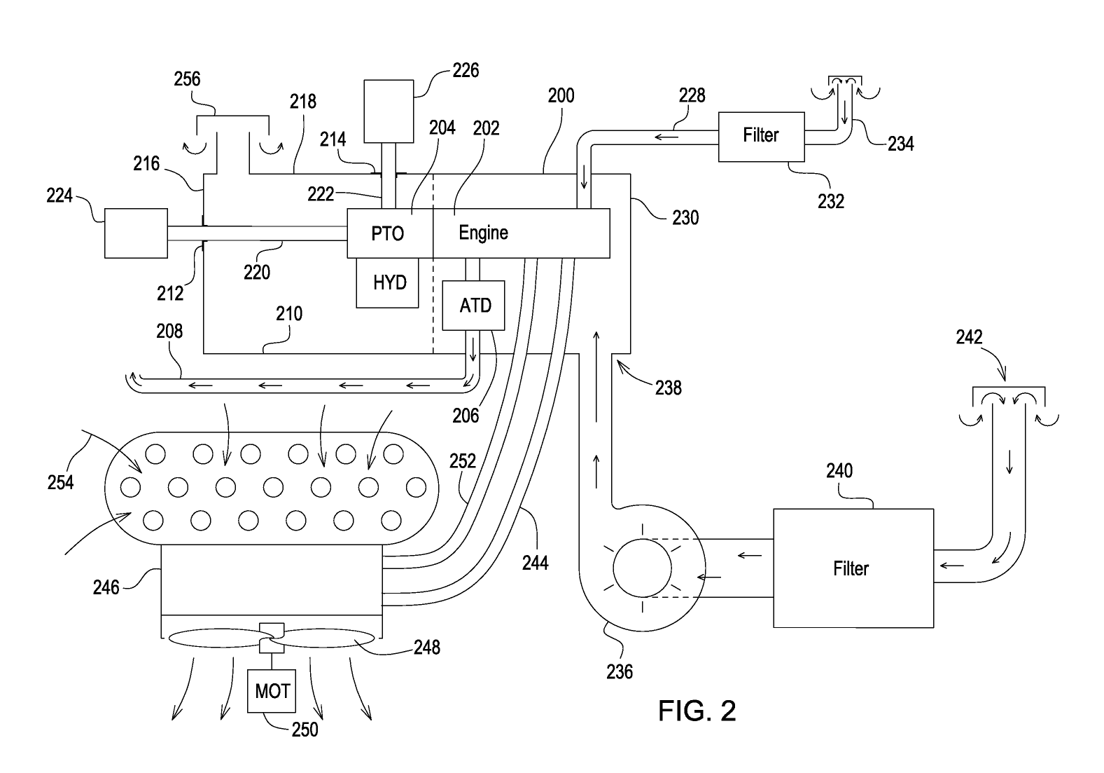

Referring to an alternative arrangement shown in FIG. 2, an engine enclosure 200 surrounds an internal combustion engine 202 that is coupled to a gearbox 204. An exhaust gas aftertreatment device 206 is coupled to internal combustion engine 202 to receive exhaust gas therefrom. The exhaust gas aftertreatment device 206 is internally configured to treat the exhaust gas to reduce the atmospheric contaminants entrained therein. A typical exhaust gas aftertreatment device 206 is a diesel particulate filter, which cycles from cool to extremely hot when it is regenerated. An exhaust gas outlet 208 extends from the exhaust gas aftertreatment device 206 through a wall 210 of the engine enclosure 200. Aperture 212 and aperture 214 are provided in wall 216 and wall 218, respectively, of the engine enclosure 200. Aperture 212 and aperture 214 surround output drive shaft 220 and output drive shaft 222, respectively. The output drive shaft 220 and the output drive shaft 222 extend from the gearbox 204. The output drive shaft 220 and the output drive shaft 222 extend through the wall 216 and the wall 218 and are coupled to the driven machine 224 and the driven machine 226, respectively to communicate power from the gearbox 204 to the driven machine 224 and the driven machine 226. The driven machine 224 and the driven machine 226 are disposed outside of the engine enclosure 200. A combustion air conduit 228 for the internal combustion engine 202 extends through a wall 230 of engine enclosure 200. The combustion air conduit 228 is coupled to and receives air from and air filter 232 that is disposed outside of the engine enclosure 200. The air filter 232 has an air inlet 234 that receives air from the ambient environment outside the engine enclosure 200. A fan 236 is coupled to an air inlet 238 disposed in the wall 210 of the engine enclosure 200. The fan 236 is disposed outside of the engine enclosure 200. The inlet of the fan 236 is connected to an air filter 240. The air filter 240 has an air inlet 242 that is open to receive air from the ambient environment outside the engine enclosure 200.

A first engine coolant conduit 244 is coupled to the internal combustion engine 202 to receive hot engine coolant therefrom and to conduct the hot engine coolant from the internal combustion engine 202 through the wall 210 of the engine enclosure 200, and to a heat exchanger 246 for cooling engine coolant. A fan 248 is driven by a motor 250 and is disposed to move ambient air 254 through the heat exchanger 246 thereby cooling the hot engine coolant. The now-cool engine coolant is conveyed from the heat exchanger 246 into a second engine coolant conduit 252 which is coupled to the heat exchanger 246. The second engine coolant conduit 252 is disposed to convey the cool engine coolant back to the internal combustion engine 202. The second engine coolant conduit 252 passes through the wall 210 of the engine enclosure 200. As in the example of FIG. 1, an air vent 256 is provided in the wall 218 of the engine enclosure 200 to permit excess air inside the engine enclosure 200 to be released into the ambient environment, thereby preventing overpressure of the engine enclosure 200.

The heat exchanger 246 is disposed outside of the engine enclosure 200 such that the ambient air 254 is drawn from the ambient environment surrounding the engine enclosure 200, passes through the heat exchanger 246, and is returned to the ambient environment surrounding the engine enclosure 200 without passing into or out of the engine enclosure 200. In this way, the large quantities of air necessary for cooling the hot engine coolant need not be filtered in order to remove the large quantities of debris as is necessary in the traditional arrangement. In the traditional arrangement, as described above, air passing through the heat exchanger 246 for cooling engine coolant is then passed over and around the engine and other hot surfaces such as surfaces of the internal combustion engine 202, the exhaust gas aftertreatment device 206, and the exhaust gas outlet 208.

I claim:

1. An engine enclosure (100, 200) for an internal combustion engine (102, 202) comprises a plurality of walls (114, 210, 216, 218, 230) surrounding the internal combustion engine (102, 202), wherein the walls define an air inlet (120, 238) opening into a space between the internal combustion engine (102, 202) and the plurality of walls (114, 210, 216, 218, 230), and the fan (122, 236) coupled to the air inlet (120, 238) to provide air under pressure to the space between the internal combustion engine (102, 202) and the plurality of walls (114, 210, 216, 218, 230), and to maintain the air in the space at a pressure above the air pressure outside the plurality of walls (114, 210, 216, 218, 230).

2. The engine enclosure (100, 200) of claim 1, further comprising a combustion air conduit (116, 228) coupled to the internal combustion engine (102, 202) to supply the internal combustion engine (102, 202) with air for internal combustion, wherein at least a portion of said combustion air conduit (116, 228) is disposed inside the engine enclosure (100, 200).

3. The engine enclosure (100, 200) of claim 2, wherein the combustion air conduit (228) extends through a wall of the plurality of walls (114, 210, 216, 218, 230).

4. The engine enclosure (100, 200) of claim 3, wherein an end of the combustion air conduit (228) is disposed outside of the engine enclosure (100, 200) to receive ambient air from the environment outside of the engine enclosure (100, 200) and to conduct the ambient air through the wall of the plurality of walls (114, 210, 216, 218, 230) and into the internal combustion engine (102, 202).

5. The engine enclosure (100, 200) of claim 1, wherein the fan (122, 236) is disposed to receive ambient air from outside the engine enclosure (100, 200), and to convey the ambient air into the air inlet (120, 238).

6. The engine enclosure (100, 200) of claim 5, wherein an air filter (124, 240) is disposed between the fan (122, 236) and the ambient environment to filter ambient air before it is conveyed into the air inlet (120, 238).

7. The engine enclosure (100, 200) of claim 1, further comprising a heat exchanger (246) disposed outside of the engine enclosure (100, 200), and configured to receive ambient air (254) from the ambient environment outside of the engine compartment, to transfer heat to the ambient air (254) and to transmit now-heated ambient air back into the ambient environment outside of the engine compartment.

8. The engine enclosure (200) of claim 7, further comprising a first engine coolant conduit (244) coupled to and extending between the internal combustion engine (202) and the heat exchanger (246) to conduct hot engine coolant from the internal combustion engine (202) to the heat exchanger (246) for cooling, and a second engine coolant conduit (252) coupled to and extending between the internal combustion engine (202) and the heat exchanger (246) to conduct engine coolant from the heat exchanger (246) back to the internal combustion engine (202) after cooling.

9. The engine enclosure (200) of claim 8, wherein the first engine coolant conduit (244) and the second engine coolant conduit (252) extend through a wall (210) of the engine enclosure (200).

10. The engine enclosure (100, 200) of claim 1, further comprising a gearbox (104, 204) disposed inside the plurality of walls (114, 210, 216, 218, 230) and coupled to the internal combustion engine (102, 202) to be driven thereby.

11. The engine enclosure (200) of claim 10, further comprising an output drive shaft (220, 222) coupled to and driven by the gearbox (204).

12. The engine enclosure (200) of claim 11, wherein the output drive shaft (220, 222) extends through a wall (216) of the plurality of walls (114, 210, 216, 218, 230).

13. The engine enclosure (200) of claim 12, wherein the output drive shaft (220, 222) is coupled to and drives a driven machine (224, 226) disposed outside of the plurality of walls (114, 210, 216, 218, 230).

14. The engine enclosure (100, 200) of claim 1, further comprising an air vent (132, 256) extending from a wall of the plurality of walls (114, 210, 216, 218, 230) and configured to communicate air from inside the engine enclosure (100, 200) to the ambient atmosphere outside of the engine enclosure (100, 200) thereby preventing overpressure of the engine enclosure (100, 200).

15. The engine enclosure (100) of claim 1 wherein the plurality of walls (114) enclose a turbocharger (106) that is coupled to the internal combustion engine (102) to pressurize combustion air for the internal combustion engine (102).

16. The engine enclosure (100, 200) of claim 1, wherein the fan (122, 236) is not disposed to impel air through an engine coolant heat exchanger.

17. The engine enclosure (100, 200) of claim 1, wherein the air inlet (120, 238) is not disposed to communicate air passing through an engine coolant heat exchanger into the engine enclosure (100, 200).
